(19) United States
(12) Patent Application Publication
(10) Pub. No.: US 2023/0325727 A1
(43) Pub. Date: Oct. 12, 2023

(54) MACHINE LEARNING PLATFORM FOR OPTIMIZED PROVIDER DETERMINATION AND PROCESSING

(71) Applicant: DoorDash, Inc., San Francisco, CA (US)

(72) Inventors: Lu Wang, Los Altos, CA (US); Chen Dong, San Mateo, CA (US)

(21) Appl. No.: 18/296,916

(22) Filed: Apr. 6, 2023

Related U.S. Application Data
(60) Provisional application No. 63/329,242, filed on Apr. 8, 2022.

(51) Int. Cl. G06N 20/20

(52) U.S. Cl. CPC G06N 20/20

(57) ABSTRACT

A method includes a server computer receiving a dataset comprising data associated with a plurality of service providers. The server computer can extract a plurality of features from the dataset. The features include user intent features, off-platform features, and on-platform features. The server computer can train a machine learning model using training data based on the plurality of features of at least some of the service providers. For one or more candidate service providers of the plurality of service providers, the server computer can determine a predicted rank and a predicted value for each of the one or more candidate service providers using the trained machine learning model.

### CROSS REFERENCE TO RELATED APPLICATIONS

The present application is a non-provisional application of and claims priority to U.S. Provisional Application 63/329,242, filed on Apr. 8, 2022, which is incorporated herein by reference in its entirety.

### BRIEF SUMMARY

One embodiment of the invention includes a method comprising: receiving, by a server computer, a dataset comprising data associated with a plurality of service providers; extracting, by the server computer, a plurality of features from the dataset, wherein the features include user intent features, off-platform features, and on-platform features; training, by the server computer, a machine learning model using training data based on the plurality of features of at least some of the service providers; and for one or more candidate service providers of the plurality of service providers, determining, by the server computer, a predicted rank and a predicted value for each of the one or more candidate service providers using the trained machine learning model.

Another embodiment of the invention includes a server computer comprising: a processor; and a computer-readable medium coupled to the processor, the computer-readable medium comprising code executable by the processor for implementing a method comprising: receiving, by a server computer, a dataset comprising data associated with a plurality of service providers; extracting, by the server computer, a plurality of features from the dataset, wherein the features include user intent features, off-platform features, and on-platform features; training, by the server computer, a machine learning model using training data based on the plurality of features of at least some of the service providers; and for one or more candidate service providers of the plurality of service providers, determining, by the server computer, a predicted rank and a predicted value for each of the one or more candidate service providers using the trained machine learning model.

Another embodiment of the invention includes a system comprising: a server computer comprising: a first processor; and a first computer-readable medium coupled to the first processor, the first computer-readable medium comprising code executable by the first processor for implementing a method comprising: receiving a dataset comprising data associated with a plurality of service providers; extracting, by the server computer, a plurality of features from the dataset, wherein the features include user intent features, off-platform features, and on-platform features; training a machine learning model using training data based on the plurality of features of at least some of the service providers; and for one or more candidate service providers of the plurality of service providers, determining a predicted rank and a predicted value for each of the one or more candidate service providers using the trained machine learning model; and a logistics platform comprising: a second processor; and a second computer-readable medium coupled to the second processor, the second computer-readable medium comprising code executable by the second processor.

Further details regarding these and other embodiments can be found in the Detailed Description and the Figures.

### BRIEF DESCRIPTION OF THE DRAWINGS

FIG. 1 shows a block diagram of a machine learning system according to embodiments.

FIG. 2 shows a block diagram of components of a central server computer according to embodiments.

FIG. 3 shows a flow diagram illustrating a method for delivering one or more items provided by service providers to end users according to embodiments.

FIG. 4 shows a flow diagram of a feature extraction method according to embodiments.

FIG. 5 shows a block diagram illustrating a time window for label generation according to embodiments.

FIG. 6 shows a flow diagram of a machine learning method according to embodiments.

FIG. 7 shows a graph illustrating a feature contribution by score according to embodiments.

### DETAILED DESCRIPTION

Prior to discussing embodiments of the invention, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

A “transporter” can be an entity that transports something. A transporter can be a person that transports a resource using a transportation device (e.g., a car). In other embodiments, a transporter can be a transportation device that may or may not be operated by a human. Examples of transportation devices include cars, boats, scooters, bicycles, drones, airplanes, etc.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, completed state, or a final state. After the fulfillment request is in a final state, it can be accepted by the central server computer, and the central server computer can send a fulfillment request confirmation to the end user device. A fulfillment request can include one or more selected items from a selected service provider. A fulfillment request can also include user features of the end user providing the fulfillment request.

An “item” can include an individual article or unit. An item can be a thing that is provided by a service provider. Items can be a goods. For example, an item can be a bowl of soup, a soda can, a toy, clothing, etc. An item can be a thing that is delivered from a service provider location to an end user location by a transporter.

The term “artificial intelligence model” or “AI model” can include a model that may be used to predict outcomes in order achieve a pre-defined goal. The AI model may be developed using a learning algorithm, in which training data is classified based on known or inferred patterns. An AI model may also be referred to as a “machine learning model” or “predictive model.”

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that an end user might enjoy).

In some embodiments, a model may be a statistical model, which can be used to predict unknown information from known information. For example, the machine learning model can be associated with a learning module may be a set of instructions for generating a regression line from training data (supervised learning) or a set of instructions for grouping data into clusters of different classifications of data based on similarity, connectivity, and/or distance between data points (unsupervised learning). The regression line or data clusters can then be used as a model for predicting unknown information from known information. Once model has been built from the learning module, the model may be used to generate a predicted output from a new request. A new request may be a request for a prediction associated with presented data. For example, a new request may be a request for classifying an image or for creating a recommendation for a user.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs.

A “feature” can be an individual measurable property or characteristic of a phenomenon. A feature can be described by a feature vector. A feature can be input into a model to determine an output. As an example, in pattern recognition and machine learning, a feature vector is an n-dimensional vector of numerical features that represent some object. Algorithms in machine learning require a numerical representation of objects since such representations facilitate processing and statistical analysis. When representing images, the feature values might correspond to the pixels of an image. When representing text, however, the features might be the frequencies of occurrence of textual terms. Feature vectors are equivalent to the vectors of explanatory variables used in statistical procedures such as linear regression. Feature vectors can be combined with weights using a dot product in order to construct a linear predictor function that is used to determine a score for making a prediction.

A “server computer” can include a powerful computer or cluster of computers. For example, the server computer can be a large mainframe, a minicomputer cluster, or a group of servers functioning as a unit. In one example, the server computer may be a database server coupled to a Web server. A server computer can also include a cloud computer.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” can include any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

End users often use websites and other technologies to purchase items from service providers for delivery to the end user. In some instances, a delivery platform may facilitate deliveries for the service providers. For example, a delivery platform may provide an online website that identifies items from multiple service providers that are available for delivery by the delivery platform. An end user may navigate to the online site, select an item from a service provider, specify an address for delivery, and purchase the item for delivery to the end user's address. The delivery platform may then utilize various resources to fulfill delivery of the item to the end user. For example, the delivery platform may communicate with a transporter to retrieve the item from the merchant, and then deliver the item to the customer's address.

The delivery platform can facilitate deliveries for some service providers. There can be many different service provider prospects that can cooperate with the delivery platform. However, it is difficult to determine which service providers may ultimately be successful when cooperating with the delivery platform. Further, it is time consuming to communicate with each service provider to evaluate whether or not to cooperate with the service provider, since there are over 82,000 eating and drinking establishments alone in California (according to the national restaurant association).

Embodiments of the invention address these and other problems individually and collectively.

Embodiments relate to a machine learning system and method. A central server computer can operate and maintain a platform (e.g., a delivery platform). A central server computer can obtain a dataset that includes data from external data sources and internal data sources. The dataset can include data relating to both on-platform service providers and off-platform service providers.

The central server computer can extract features from the dataset. The central server computer can obtain the features using principle component analysis, independent component analysis, linear discriminant analysis, local linear embeddings, and/or autoencoders, and/or other feature extraction process.

After extracting the features, the central server computer can train a machine learning model using the dataset and features that relate to service providers. The machine learning model can be trained to determine a predicted value and a predicted rank for each service provider. In some embodiments, the machine learning model can be a gradient boosted trees supervised learning model with a squared error loss function. The predicted value can be a value related to the performance of the service provider (e.g., monthly sales, number of items provided per day, gross merchandise volume (GMV), etc.). The predicted rank can be a value related to how the predicted value ranks in comparison to other service provider's values.

The central server computer can then utilize the trained machine learning model to determine a predicted value and a predicted rank for candidate service providers. For example, the central server computer can input data relating to a first candidate service provider into the trained machine learning model. The output of the trained machine learning model can be a predicted value and a predicted rank for the candidate service provider.

After determining the predicted values and the predicted ranks, the central server computer can evaluate the predicted rank and the predicted value for each of the one or more candidate service providers to determine which service providers would successfully perform when allowed to use the central server computer for service processing (e.g., delivery processing). The central server computer can then select at least one of the one or more candidate service providers to onboard to the platform (e.g., use the server computer in the platform).

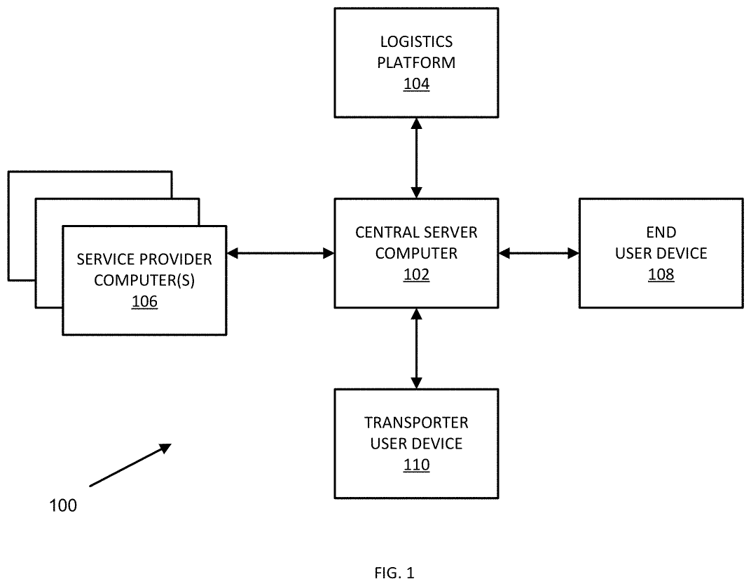

FIG. 1 shows block diagram of a system 100 according to embodiments. The system 100 includes a central server computer 102, a logistics platform 104, one or more service provider computers 106, an end user device 108, and a transporter user device 110.

The central server computer 102 can be in operative communication with the logistics platform 104, the one or more service provider computers 106, the end user device 108 and the transporter user device 110. In some embodiments, there may be a plurality of end user devices and/or a plurality of transporter user devices that are in operative communication with the central server computer 102.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between at least the devices of system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can be a server computer. The central server computer 102 can maintain and operate a platform. The platform can be a delivery platform that delivers items offered by service providers to end users via transporters. Illustratively, a service provider may be a restaurant that sells pizza. The central server computer 102 can be operated by a food delivery organization that can aid in the delivery of pizza via transporters to end users that seek to purchase the pizza from the restaurant using the central server computer 102.

In embodiments, service providers can be enrolled (e.g., onboarded) with the platform in order to provide items to the end users via the transporters. The central server computer 102 can evaluate off-platform service providers to determine suitable candidate service providers. The central server computer 102 can onboard one or more of the suitable candidate service provider to be on-platform service providers.

The central server computer 102 can facilitate the fulfillment of fulfillment requests received from the end user device 108. For example, the central server computer 102 can identify one or more transporters operating one or more transporter user devices that are capable of satisfying the fulfillment request. The central server computer 102 can identify the transporters that can satisfy the fulfillment request based on any suitable criteria (e.g., transporter location, service provider location, end user destination, end user location, transporter mode of transportation, etc.). The logistics platform 104 may provide real time data regarding locations of the various service providers, transporters, and end users to the central server computer 102.

The logistics platform 104 can include a location determination system, which can determine the location of various user devices such as transporter user devices (e.g., transporter user device 110) and end user devices (e.g., end user device 108). The logistics platform 104 can also include routing logic to efficiently route a transporter using the transport user device 110 to various service providers that have the resources that are to be delivered to the end users. The logistics platform 104 can be part of the central server computer 102 or can be system that is separate from the central server computer 102.

The one or more service provider computers 106 may communicate with the central server computer 102 via one or more APIs. The one or more service provider computers 106 may initially present resources such as goods and/or services to end users via an application on the end user device 108. In some embodiments, a service provider has a resource that the end user wants to obtain. In embodiments of the invention, an end user can interact with an interaction application on an end user device to purchase a resource from the service provider.

The one or more service provider computers 106 can include computers operated by service providers. For example, a service provider computer can be a food provider computer that is operated by a food provider. The one or more service provider computers 110 can offer to provide services to the end users of end user devices. The one or more service provider computers 106 can receive requests to prepare one or more items for delivery from the central server computer 102. The one or more service provider computers 106 can initiate the preparation of the one or more items that are to be delivered to the end user of the end user device 108 by a transporter of a transporter user device 110.

The end user device 108 can include a device operated by an end user. The end user device 108 can generate and provide a fulfillment request message to the central server computer 102 to request delivery of an item from a service provider computer to the end user of the end user device 108. The fulfillment request message can indicate that the request (e.g., a request for a service) can be fulfilled by one or more service providers associated with the service provider computers 110. For example, the fulfillment request message can be generated based on a cart selected at checkout during a transaction using a central server computer application installed on the end user device 108. The fulfillment request message can include one or more items from the selected cart.

The transporter user device 110 can be a device operated by a transporter. The transporter user device 110 can include smartphones, wearable devices, personal assistant devices, etc. In embodiments of the invention, the central server computer 102 can notify the transporter user device 110 of the fulfillment request. The transporter user device 110 can respond to the central server computer 102 with a request to perform the delivery to the end user as indicated by the fulfillment request.

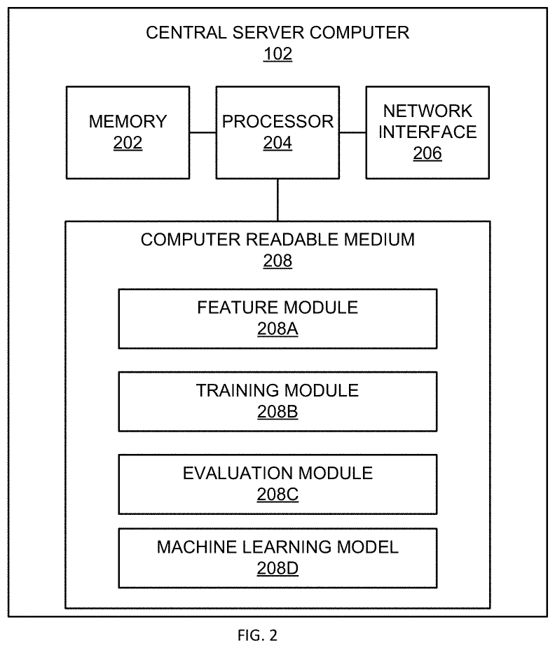

FIG. 2 shows a block diagram of a central server computer 102 according to embodiments. The exemplary central server computer 102 may comprise a processor 204. The processor 204 may be coupled to a memory 202, a network interface 206, and a computer readable medium 208. The computer readable medium 208 can comprise a feature module 208A, a training module 208B, an evaluation module 208C, and a machine learning model 208D.

The memory 202 can be used to store data and code. For example, the memory 202 can store input data, features, machine learning models, weights, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a server computer, a dataset comprising data associated with a plurality of service providers; extracting, by the server computer, a plurality of features from the dataset, wherein the features include user intent features, off-platform features, and on-platform features; training, by the server computer, a machine learning model using training data based on the plurality of features of at least some of the service providers; and for one or more candidate service providers of the plurality of service providers, determining, by the server computer, a predicted rank and a predicted value for each of the one or more candidate service providers using the trained machine learning model.

The feature module 208A may comprise code or software, executable by the processor 204, for determining and/or evaluating features. The feature module 208A, in conjunction with the processor 204, can extract features from a dataset. Feature extraction can start from an initial set of measured data (e.g., data from the dataset). The feature module 208A, in conjunction with the processor 204, can obtain the dataset from a memory or database. The feature module 208A, in conjunction with the processor 204, can build derived values (e.g., features) from the dataset that can be intended to be informative and non-redundant, facilitating the subsequent learning and generalization steps, and in some cases leading to better human interpretations. Feature extraction can be related to dimensionality reduction of the dataset.

When the input data to an algorithm is too large to be processed and it is suspected to be redundant (e.g., the same measurement in both feet and meters, or the repetitiveness of images presented as pixels), then it can be transformed into a reduced set of features (also named a feature vector). Determining a subset of the initial features is called feature selection. The selected features can contain the relevant information from the input data, so that the desired task (e.g., determining predicted values and predicted ranks) can be performed by using this reduced representation instead of the complete initial data.

The feature module 208A, in conjunction with the processor 204, can perform feature extraction/dimensionality reduction techniques including independent component analysis, isomap creation, principle component analysis, latent semantic analysis, partial least squares, multifactor dimensionality reduction, nonlinear dimensionality reduction, embedding, autoencoders, etc.

The training module 208B can include may comprise code or software, executable by the processor 204, for training machine learning model(s). The process of training a machine learning model involves providing a machine learning algorithm with training data to learn from. The training module 208B, in conjunction with the processor 204, can input training data into the machine learning model for training. The training data can include labels that indicate the target attribute of the data (e.g., a label indicating a value and rank that the machine learning model is trained to determine).

The training module 208B, in conjunction with the processor 204, can aid the learning algorithm in finding patterns in the training data that map the input data attributes to the target. The training module 208B, in conjunction with the processor 204, can output a trained machine learning model that captures these patterns.

The training module 208B, in conjunction with the processor 204, can further train the trained machine learning model with additional training data that may be obtained after the initial training is complete. The training module 208B, in conjunction with the processor 204, can continuously train the trained machine learning model over time.

In some embodiments, the training module 208B, in conjunction with the processor 204, can train a gradient boosted trees model. The gradient boosted trees model can be an XGBoost model, which is an open-source implementation of the gradient boosted trees algorithm. Gradient boosting is a supervised learning algorithm that attempts to accurately predict a target variable by combining the estimates of a set of simpler, weaker models. When using gradient boosting for regression, the weak machine learning algorithms are regression trees. Each regression tree can map an input data point to one of its leaves that contains a continuous score. XGBoost minimizes a regularized (L1 and L2) objective function that combines a convex loss function (based on the difference between the predicted and target outputs) and a penalty term for model complexity (e.g., the regression tree functions). The training proceeds iteratively, adding new trees that predict the residuals or errors of prior trees that are then combined with previous trees to make the final prediction. It is called gradient boosting because it uses a gradient descent algorithm to minimize the loss when adding new models.

The evaluation module 208C can include may comprise code or software, executable by the processor 204, for evaluating data and machine learning model(s). The evaluation module 208C, in conjunction with the processor 204, can utilize the trained machine learning model to obtain predictions on new data for which the target (e.g., the predicted value and the predicted rank) are unknown. The evaluation module 208C, in conjunction with the processor 204, can input candidate service provider data into the trained machine learning model for evaluation. The trained machine learning model can output a predicted value and a predicted rank for the input candidate service provider.

The machine learning module 208D can include any of the above described machine learning models including neural networks, support vector machines, XGBoost models, etc.

The network interface 206 may include an interface that can allow the central server computer 102 to communicate with external computers. The network interface 206 may enable the central server computer 102 to communicate data to and from another device (e.g., the logistics platform 104, the one or more service provider computers 106, the end user device 108, the transporter user device 110, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

In some embodiments, the central server computer 102 may be in operative communication with one or more databases. For example, the central server computer 102 can communicate with a dataset database and/or a features database. The databases may be conventional, fault tolerant, relational, scalable, secure databases such as those commercially available from Oracle™ or Sybase™.

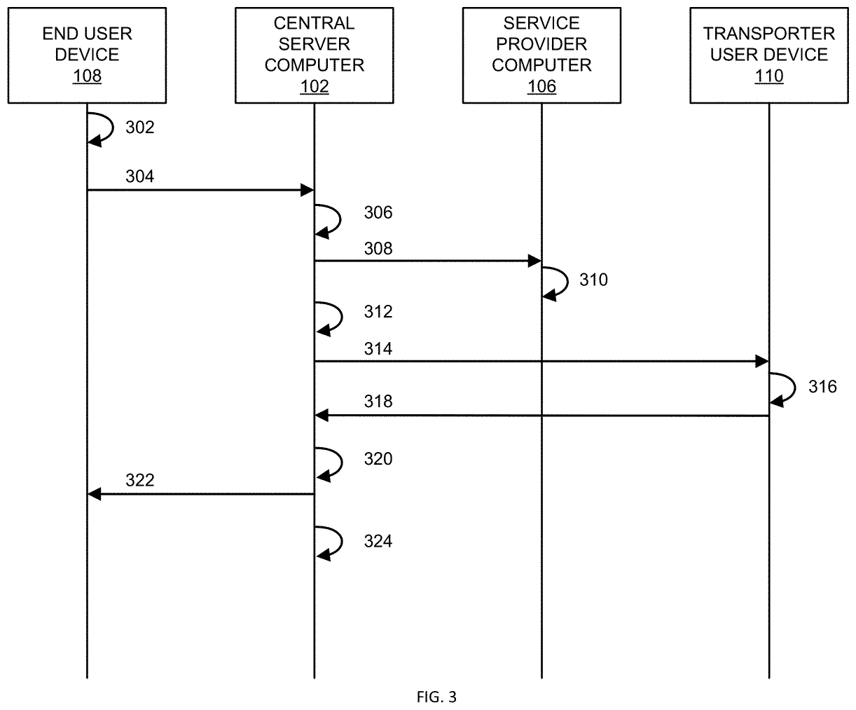

FIG. 3 shows a flow diagram illustrating a preparation and delivery method according to embodiments. The method illustrated in FIG. 3 will be described in the context of the central server computer 102 receiving a fulfillment request message from the end user device 108 to fulfill preparation and delivery of one or more items from a cart to the end user of the end user device 108. The central server computer 102 can communicate with the service provider computer 106 and the transporter user device 110 to fulfill the fulfillment request.

At step 302, the end user device 108 can decide to check out with a cart in a central server computer application installed on the end user device 108. The cart can include one or more items that are provided from a service provider of the service provider computer 106.

At step 304, after checking out with the cart, the end user device 108 can provide a fulfillment request message including the one or more items from the cart to the central server computer 102. The fulfillment request message can also include a service provider computer identifier that identifies the service provider computer 106.

At step 306, after receiving the fulfillment request message, the central server computer 102 can perform a transaction process with the end user device 108. For example, the central server computer 102 can communicate with a payment network to process the transaction for the one or more items. The central server computer 102 can receive an indication of whether or not the transaction is authorized. If the transaction is authorized, then the central server computer 102 can proceed with step 308.

At step 308, the central server computer 102 can provide the fulfillment request message, or a derivation thereof, to the service provider computer 106. The central server computer 102 can determine which service provider computer of a plurality of service provider computers to communicate with based on the service provider indicated in the fulfillment request message. For example, the fulfillment request message can indicate that the one or more items are provided by the service provider of the service provider computer 106. The central server computer 102 can identify the service provider computer 106 using the service provider computer identifier in the fulfillment request message.

At step 310, after receiving the fulfillment request message, the service provider computer 106 can initiate preparation of the one or more items. For example, the service provider computer 106 can alert service providers (e.g., those preparing the items) at the service provider location. The service providers can prepare the one or more items for pick up by a transporter.

At step 312, after providing the fulfillment request message to the service provider computer 106, the central server computer 102 can determine one or more transporters operating one or more user devices that are capable of fulfilling the fulfillment request message. The central server computer 102 can determine the one or more transporters from the transporter user devices. The central server computer 102 can determine the one or more transporter user devices based on whether or not the transporter user device is online, whether or not the transporter user device is already fulfilling a different fulfillment request message, a location of the transporter user device, etc.

At step 314, after determining the one or more transporter user devices, the central server computer 102 can provide the fulfillment request message, or a derivation thereof, to the one or more transporter user devices including the transporter user device 110.

At step 316, after receiving the fulfillment request message, the transporter of the transporter user device 110 can determine whether or not they want to perform the fulfillment. The transporter can decide that they want to perform the delivery of the one or more items from the service provider location to the end user location. The transporter user device 110 can generate an acceptance message that indicates that the fulfillment request is accepted.

At step 318, after generating the acceptance message, the transporter user device 110 can provide the acceptance message to the central server computer 102.

After providing the acceptance message to the central server computer 102, the transporter user device 110 can communicate with the navigation network 116 and the transporter can proceed to the service provider location to obtain the one or more items. The transporter user device 110 can then receive input from the transporter that indicates that the transporter obtained the one or more items (e.g., the transporter selects that they picked up the items). The transporter user device 110 can then communicate with the navigation network 116 and the transporter can then proceed to the end user location to provide the one or more items to the end user. In some embodiments, the transporter user device 110 can provide update messages to the central server computer 102 that include a transporter user device 110 location and/or event data (e.g., items picked up, items delivered, etc.).

In some embodiments, after receiving the acceptance message, the central server computer 102 can notify the other transporter user devices that received the fulfillment request message that the fulfillment request is no longer available.

At step 320, at any point after receiving the acceptance message, the central server computer 102 can check the status of the fulfillment request. For example, the central server computer 102 can determine the location of the transporter user device 110 and can determine an estimated amount of time for the transporter user device 110 to arrive at the end user location.

At step 322, the central server computer 102 can provide an update message to the end user device 108 that includes data related to the fulfillment of the fulfillment request message. The data can include an estimated amount of time, the transporter user device location, event data (e.g., items picked up from the service provider), and/or other data related to the fulfillment of the fulfillment request message.

At step 324, the central server computer 102 can store any data received, sent, and/or processed during the fulfillment of the fulfillment request message into a database. For example, the central server computer 102 can store a user's cart selection as user features into a user feature database.

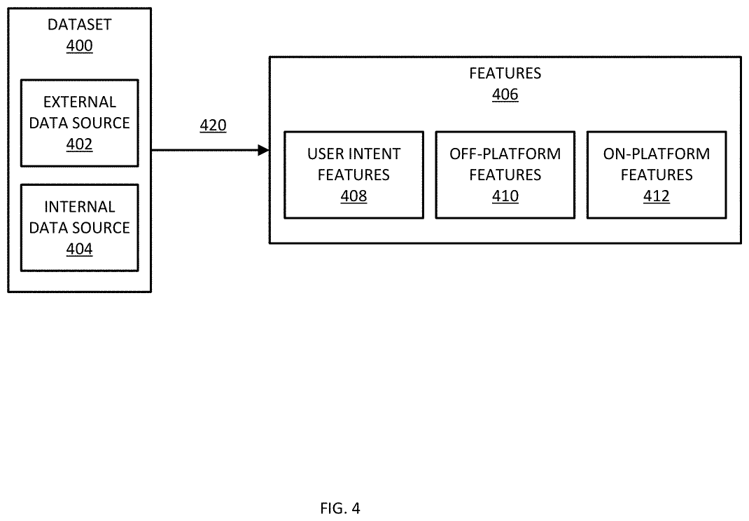

FIG. 4 shows a flow diagram of a feature extraction method according to embodiments. The method illustrated in FIG. 4 will be described in the context of a central server computer receiving one or more datasets associated with a plurality of service provider computers. It is understood, however, that the invention can be applied to other circumstances (e.g., receiving features from a dataset processing computer, etc.). The datasets and features described in reference to FIG. 4 can include information that can be utilized by a machine learning process, described herein, to select candidate resource providers.

FIG. 4 includes a dataset 400 and features 406. The dataset 400 can include data from an external data source 402 and data from an internal data source 404. The features 406 can include user intent features 408, off-platform features 410, and on-platform features 412.

To identify the potential candidate resource providers, the central server computer can attempt to determine a value that represents an off-platform resource provider. The value can be a value that represents information regarding to the onboarding of the off-platform resource provider to the platform (e.g., allow the service provider to utilize the server computer to perform service processing, such as delivery processing). To provide a better selection of candidate resource providers, the central server computer can rank the off-platform service providers accurately to achieve high efficiency with limited resources. Specifically, the central server computer can create and utilize models that can discern numerical answers to a number of questions including 1) what is a numerical value of a service provider? 2) how do off-platform service providers compare to on-platform service providers? and 3) how can different regions be taken into account?

Expanding upon the first question, the central server computer can evaluate, for example, what is the value of a restaurant. The central server computer can evaluate what characteristics make a restaurant a valuable addition to the platform and/or what is the gross merchandise volume (GMV) a service provider can bring to the platform.

Expanding upon the second question, the central server computer can calculate a value (e.g., a total accessible market value) for each service provider in each geographic region. Further, the central server computer can compare the value from each service provider in each geographic region for on-platform and off-platform service providers.

Expanding upon the third question, the central server computer can evaluate resource providers in different regions (e.g., different locations, markets, etc.). Since the depth of the selection of service providers determines the total accessible market, the central server computer can evaluate what selections of service providers are missing in different regions. The central server computer can take such information about missing service providers and can onboard off-platform service providers that can fulfill those needs.

In order to address these questions, the central server computer can obtain datasets, train a machine learning model using the datasets, and utilize the machine learning model to determine candidate service providers. The machine learning model can be trained to understand what makes a service provider successful and what types of service providers users of the platform want on the platform. The central server computer can analyze off-platform service providers to estimate their potential on-platform performance. This process improves candidate service provider selection.

Specifically, embodiments include a system that compares service providers fairly at different time periods, builds features for model prediction, and validates model performance.

The central server computer can obtain the dataset 400 from one or more data sources. For example, the central server computer can receive data from data sources such as service providers, websites, end user devices, transporter devices, a logistics platform, a resource provider platform, etc.

The dataset 400 can include data from an external data source 402. For example, the central server computer can obtain third-party data such as Internet based review and ratings. The reviews and ratings can be matched with service providers in a database of service providers maintained by the central server computer. The reviews and ratings can be matched and assigned to the proper service provider based on the name of the service provider. External data may include information about a service provider obtained from a service provider review Website (e.g., Google™ reviews, Yelp™, etc.).

The dataset 400 can include data from an internal data source 404. For example, the central server computer can maintain a database that includes data relating to on-platform service providers. For example, the database can include on-platform service provider sales performance data, on-platform service provider names, on-platform service provider regions, on-platform service provider cuisine types, on-platform service provider open hours, and/or any other data related to on-platform service providers. Internal data can include search data or sales data of service providers that are enrolled in a platform offered by the central server computer.

In some embodiments, the data from the external data source 402 can include data that is not generated by the central server computer and the data from the internal data source 404 can include data that is generated by the central server computer.

At step 420, after obtaining the dataset 400, the central server computer can extract the features 406 from the dataset 400. Features can capture various traits or information about each service provider, such as business type—for instance, local service providers versus chain-store service providers—and geolocation. The features 406 can be used to generate labels and training datasets for a machine learning method.

The central server computer can build derived values (e.g., features) from the dataset 400 that can be intended to be informative and non-redundant and can facilitate with the subsequent learning steps. The central server computer can perform feature extraction/dimensionality reduction techniques including independent component analysis, isomap creation, principle component analysis, latent semantic analysis, partial least squares, multifactor dimensionality reduction, nonlinear dimensionality reduction, embedding, autoencoders, etc.

As an example, the central server computer can utilize principal component analysis to obtain features. Principal component analysis is a technique for reducing the dimensionality of datasets. Principal component analysis can increase interpretability, but at the same time minimize information loss. Principal component analysis does so by creating new uncorrelated variables that successively maximize variance. Finding such new variables, the principal components, reduces to solving an eigenvalue/eigenvector problem, and the new variables are defined by the dataset at hand, not a priori, hence making principal component analysis an adaptive data analysis technique.

Neural networks can have difficulty with sparse categorical features. Embeddings are a way to reduce those features to increase model performance. In natural language processing (NLP) settings, a computer can typically deal with dictionaries of thousands of words. These dictionaries are one-hot encoded into the model, which mathematically is the same as having a separate column for every possible word. When a word is fed into the model, the corresponding column will show a one while all other columns will show zeros. This can lead to a sparse dataset. The solution is to create an embedding. An embedding can group words with similar meanings based on the training text and return their location in the corpus. So, for example, the word ‘fun’ might have a similar embedding value as words like ‘humor’ or ‘dancing.’

Structured datasets also often contain sparse categorical features. As an example, a dataset can include zip codes and service provider IDs. Because there may be hundreds or thousands of different unique values for these columns, utilizing them directly could create the same performance issues noted in the NLP problem above.

The central server computer is now dealing with more than one feature. In this case, two separate sparse categorical columns (zip code and service provider ID) as well as other features like sales totals, etc. The central server computer can determine embeddings using an embedding determination machine learning model that is trained to obtain useful feature vectors. For example, the central server computer can train the embeddings in a first layer of the overall machine learning model and add in the normal features alongside those embeddings. Not only does this transform zip code and store ID into useful features, but now the other useful features are not diluted away by thousands of columns.

The central server computer can store the features 406 into a feature database. The feature database can be updated with new features over time. For each service provider, embodiments can utilize features to cover a variety of aspects, including: user intent features 408; off-platform features 410; and on-platform features 412.

User intent features 408 can include features created from data relating to user searches and requests for service providers. User intent features 408 can indicate potential service provider demand. In some embodiments, the central server computer can store and process daily end user search queries. Term frequency-inverse document frequency (tf-dif) matching can also be applied to match queries to both on-platform and off-platform service provider names. Term frequency-inverse document frequency can be a numerical statistic that can reflect how important a word is to a document in a corpus. The term frequency-inverse document frequency value increases proportionally to the number of times a word appears in the document and is offset by the number of documents in the corpus that contain the word, which helps to adjust for the fact that some words appear more frequently in general.

Another user intent feature 408 can include user requests. The central server computer allows users to request off-platform service providers so that certain service providers can be prioritized. For example, an end user can search for a fast food restaurant such as “Joe's Hamburgers” in a food delivery application provided by the central server computer. This restaurant may not be on the food delivery platform (or system) that is managed by the central server computer, and user intent features related to this search can include “hamburger,” “fast food,” and “Joe's Hamburgers,” since these features are related to the intent of the end user.

Additionally, user intent features 408 can be measured and evaluated in aggregate. For example, five hundred end users' searches can be evaluated to determine whether or not any trends exist in the set searches. A trend can include four hundred of the five hundred end users searching for service providers that provide a specific cuisine (e.g., Japanese cuisine). The user intent features 408 can indicate that many end users are trying to find restaurants that provide Japanese cuisine.

Off-platform features 410 can include features such as the history of sales at market level and various business segments, cuisine type, ratings, reviews, and business hours derived from off-platform sources. For example, ratings and reviews of restaurants (e.g., the number of stars and specific comments from users of the restaurants that are or that are not on the delivery platform managed by the central server computer) on third party review Websites (e.g., Yelp™) can be used as features that can be used to train the machine learning model.

The off-platform features 410 can also include service provider performance history and/or data that allows for the inference of the performance history. For example, depending on the off-platform data sources available, the central server computer can obtain off-platform features 410 including a number of locations, a rate of new locations being opened, item prices, estimated regional labor costs, estimated regional ingredient costs, etc.

The off-platform features 410 can include features that relate to off-platform service providers. The off-platform features 410 can aid the central server computer in evaluating the off-platform service providers. In some embodiments, off-platform features 410 can also include features that relate to on-platform service providers. For example, an on-platform restaurant may have reviews and ratings on third party review Websites. These reviews and ratings can be obtained by the central server computer as off-platform features 410 that relate to the on-platform service provider.

On-platform features 412 can include features that are from data obtained on-platform or from the central server computer. On-platform features can include a service provider's monthly sales when the service provider is on the platform. In another example, the ratings and reviews of restaurants that are on the platform managed by the central server computer and that have been provided by the users of a delivery application managed by the central server computer can be examples of on-platform features. As noted above, sales, delivery times, and other data collected from past deliveries to restaurants that are on the platform can be examples of on-platform features.

On-platform features 412 can include data that can be obtained by the central server computer from the platform itself. For example, on-platform features 412 can also include the service provider performance history, which can include a total number of deliveries provided, a number of cancelled deliveries, an average delivery distance from the service provider, a maximum delivery distance, an average number of fulfilled orders per hour, a maximum number of fulfilled orders per hour, etc.

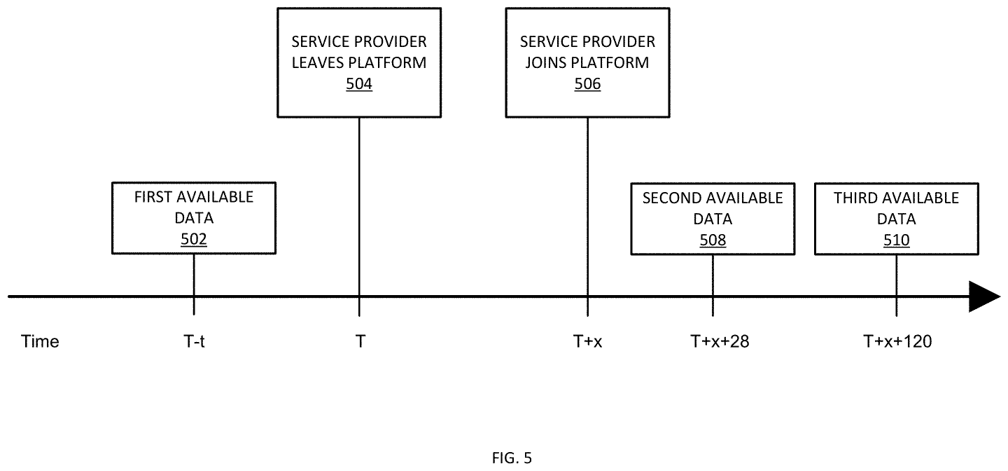

FIG. 5 shows a block diagram illustrating a time window for label generation according to embodiments. It shows when training data could be available for a service provider that leaves and joins the platform. When service providers join the platform, their performance is not representative of how they could perform after they have successfully ramped up. To measure service provider performance fairly, the central server computer can collect success metrics in a given timeframe and label them properly so that the central server computer can train the model on what successful service providers look like numerically.

The central server computer can determine labels for training datasets. The datasets can include any features mentioned herein. The labels can be the thing that the central server computer is attempting to predict during the machine learning process. The labels for the training data can aid in the training process by acting as examples of data with features and labels. For example, some of the data can relate to a service provider that is a food truck that provides food. The features of the food truck can include cuisine type, location, average review rating, etc. The label can be the output value that the machine learning model is determining (e.g., a predicted rank, a predicted value, etc.). For example, the label can be the value associated with the food truck (e.g., total accessible market value) that is known by the central server computer. The labels can aid in training the machine learning model.

To understand and predict the value of off-platform service providers, the central server computer can use data from existing service providers to discern what makes a service provider successful with to the platform. The central server computer can estimate an off-platform service provider's GMV to understand the off-platform service provider's potential value. Since the central server computer does not have direct data regarding the performance of an off-platform service provider, the central server computer can leverage what data it does have by evaluating common features from existing on-platform service providers.

In some embodiments, the value that the central server computer is attempting to predict is the GMV of the service provider. To measure the actual GMV of on-platform service provider to use in the training data, the central server computer can choose the most appropriate point in time—monthly, annually, or something in between from which to sample training data. Most service providers require time to ramp up their integration with the platform and thus new service providers do not appear to be immediately successful because of onboarding obstacles (e.g., POS or tablet set-up, slow uptake in search rankings, or limited recommendations, etc.). The central server computer can develop labels that are calculated in the period of time when new service providers most likely would show their true potential. Typically, service provider sales can stabilize four months after activation. As such, the central server computer can utilize the fifth month GMV as the label for initial exploration and modeling. However, it is understood that any period of time after a new service provider has been onboarded to the platform (e.g., allowed to utilize the server computer to perform service processing) can be utilized as the label for initial exploration and modeling (e.g., 4.5 months, 6 months, 120 days, 1 year, etc.).

When generating the labels for training datasets the central server computer can use store-level subtotals from day 120 through day 148 after activation. The central server computer can use this time window rather than the fifth month to ensure that the aggregation window is consistent for all service providers. For service providers that leave and join (e.g., activate and deactivate) the platform multiple times, the central server computer can use the last activation date as the reference point.

The data obtained about the service provider computer starting at a predetermined amount of time after onboarding (e.g., 120 days) and ending a time after (e.g., one month) can be used to compare the off-platform service providers to on-platform service providers.

FIG. 5 illustrates various events and timestamps that illustrate what data the central server computer can utilize over time. At a first timestep 502, the central server computer can obtain and utilize available data for a service provider on the platform. The first available data 502 can include all previous data for the service provider computer from 120 days after service provider onboarding to time T-t.

At timestep 504, the service provider computer can leave the platform. As such at and after time T, no data relating to the service provider computer is available.

At timestep 506, the service provider computer can re-join the platform. However, the service provider computer can be considered to be within the initial onboarding time. The central server computer cannot yet utilize data from the service provider computer until the service provider computer has been on the platform for the predetermined amount of time (e.g., 120 days).

At timestep 508, the second available data can still be empty since the service provider computer has not yet been on the platform for the predetermined amount of time.

At timestep 510, the third available data can begin to include service provider data (e.g., performance data, etc.) starting at the predetermined amount of time after onboarding.

Even though the data after the predetermined amount of time (e.g., fifth month GMV) can be used to compare off-platform service providers, the central server computer can further utilize data during other months to improve the prediction accuracy of the machine learning model. The central server computer can enrich the training dataset by including all data for each service provider after their activation date. Total data size can be increased more than ten-fold when the central server computer also utilizes features such as service provider age (number of months a service provider has been on the platform) to further increase accuracy.

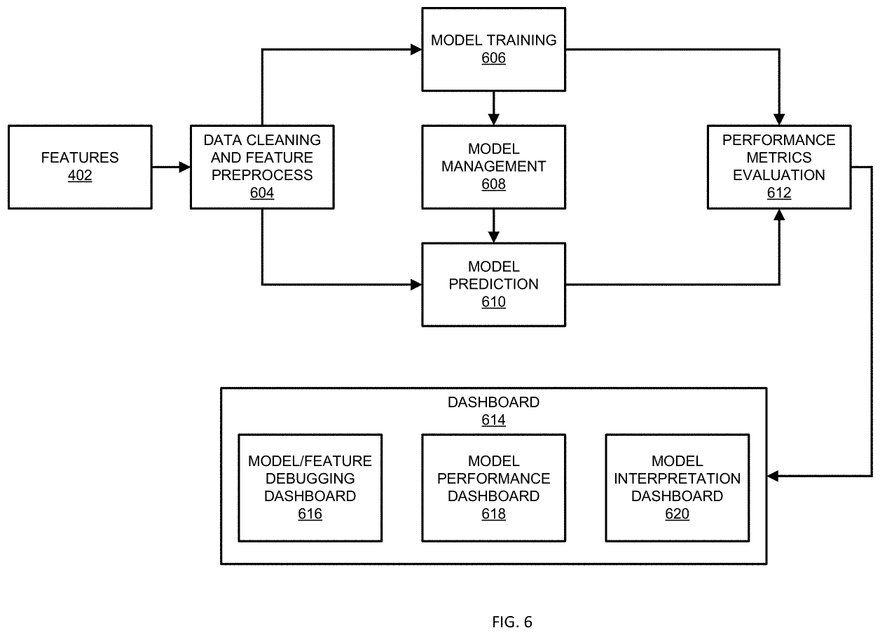

FIG. 6 shows a flow diagram of a machine learning method according to embodiments. The method illustrated in FIG. 6 will be described in the context of a central server computer training a machine learning model, evaluating candidate service providers using the machine learning model, and selecting one or more candidate service providers based on outputs from the machine learning model. It is understood, however, that the invention can be applied to other circumstances. Embodiments can utilize a machine learning model and corresponding loss function. To predict a continuous variable (such as the monthly GMV) several standard regression models and tree-based regression models were compared. They included linear regression models and LightGBM models.

Prior to step 604, during the method illustrated with respect to FIG. 4, the central server computer can obtain and/or generate the training dataset with appropriate labels and related features.

At step 604, the central server computer can perform data cleaning and feature preprocessing. The central server computer can clean the dataset that includes data from the external data source and data from the internal data source. For example, the central server computer can detect and correct corrupt or inaccurate records from a record set, table, or database and/or may identify incomplete, incorrect, inaccurate or irrelevant parts of the data and then replace, modify, or delete the dirty data. In a specific example, sales data of on-platform service providers can stabilize after a five-month period, as described herein. As such, the data of an on-platform service provider that is used for training can be cleaned to only include data after the five-month period.

The central server computer can also preprocess the features. The central server computer can preprocess the features using normalization (e.g., min-max normalization, Z-score normalization, etc.), outlier removal, rank transformations, log transformations, and/or other mathematical operations that can be applied to the feature data.

During data cleaning and feature preprocessing, the central server computer can also segment the data. The central server computer can segment the data based on service provider characteristics. For example, the central server computer can segment the data based on whether or not the service provider is new to the platform, whether or not the service provider has previously left the platform and rejoined, whether or not the service provider is a chain-store, whether or not the service provider is a local service provider to an area, etc.

In some embodiments, discrete service provider segments have demonstrated differences in the relationship between monthly GMV and feature sets, so the central server computer can create a separate model for each segment. For example, the central server computer can train a first machine learning model using data related to chain-store service providers and can train a second machine learning model using data related to service providers that are not chain-stores. By doing so, the central server computer can later more accurately determine values and ranks for candidate service providers based on the characteristics of the candidate service providers.

At step 606, after cleaning the data and preprocessing the features, the central server computer can train one or more machine learning models. For example, the central server computer can train a first machine learning model using first training data based on the plurality of features of a first group of the service providers. The central server computer can train a second machine learning model using second training data based on the plurality of features of a second group of the service providers. The first group can include service providers associated with a first characteristic. The second group can include service providers associated with a second characteristic. As an example, the first characteristic can be that the service providers are chain service providers, while the second characteristic can be that the service providers are local service providers.

The machine learning model can be a gradient boosted trees supervised learning model with a squared error loss function. As an example, the central server computer can generate a gradient boosted trees model that is a XGBoost model. The central server computer can generate a set of XGBoost models by different service provider segments to predict values (e.g., monthly sales) on the platform for each service provider.

To predict service providers with higher values (e.g., higher GMVs) more accurately, embodiments can utilize a squared error as the loss function for the machine learning model due to its higher sensitivity to larger errors. The XGBoost models can be selected with tuned hyperparameters based on squared error loss.

At step 608, after training the machine learning model(s), the central server computer can perform model management. The central server computer can monitor the progression of the machine learning models and can present information relating to the machine learning models to users of the central server computer. A cloud based workspace (such as Databricks packages) can be used for model management and daily prediction. The central server computer can provide information related to the machine learning models (e.g., data, features, weights, labels, feature impact on labels, etc.) to the cloud based workspace for user viewing. In some embodiments, users can adjust the model via the cloud based workspace.

At step 610, after training the machine learning model(s) and performing model management, the central server computer can utilize the machine learning model(s) to generate values and ranks. The dataset that was cleaned during step 604, can be input into the machine learning model. The machine learning model can generate a predicted value and a predicted rank for each input service provider computer in the dataset. Table 1, below, illustrates example output.

The central server computer can determine, for one or more candidate service providers of the plurality of service providers, the predicted rank and the predicted value for each of the one or more candidate service providers using the trained machine learning model.

Table 1 illustrates example service providers along with predicted values and predicted ranks that are generated by the central server computer. For example, the central server computer can input the service provider A's data from the dataset into the trained machine learning model. The trained machine learning model can output a predicted value of 100,000 and a rank of 6. The predicted value of 100,000 can be a total accessible market (TAM) value, for example. The predicted value can be a value that indicates how well the service provider will perform once onboarded to the delivery platform. The predicted rank can be a rank value that indicates how the performance of the service provider compares to other service providers. In some embodiments, the rank can be a value that relates to market to which the service provider belongs (e.g., rank 6 in San Francisco). In this case, the service provider A may be the 6^{th} most desirable service provider in terms of the units of the predicted value.

The central server computer can also determine predicted values and predicted ranks for a service provider B, service provider C, service provider D, and service provider E. The service providers A-E can collectively be candidate service providers.

The central server computer can evaluate the predicted rank and the predicted value for each of the one or more candidate service providers to determine which service providers would successfully perform when allowed to use the central server computer for service processing. The central server computer can utilize the evaluation to select at least one of the one or more candidate service providers to use the server computer to perform service processing.

TABLE 1
Example service provider rankings

| Service Provider | Rank | Value |
|---|---|---|
| Provider A | 6 | 100,000 |
| Provider B | 9 | 50,000 |
| Provider C | 11 | 25,000 |
| Provider D | 12 | 15,000 |
| Provider E | 13 | 5,000 |

As an example, the central server computer can generate predicted values that are daily fifth-month sales predictions (e.g., a value indicating sales per day) for each off-platform candidate service provider. For example, the central server computer can evaluate service providers that are food trucks and can evaluate whether or not food trucks should be prioritized and onboarded to the delivery platform. To ensure such trends are included in the machine learning models, the machine learning models can be trained every week, month, etc. During the prediction, the central server computer can automatically pull the models from a model store to perform predictions with features which may be processed in a virtual data-warehouse, such as Snowflake.

At step 612, after determining predicted values and predicted ranks, the central server computer can evaluate performance metrics. Model performance metrics can be fed into multiple monitoring dashboards to make sure the machine learning models do not degrade over time. Further, daily predictions for all off-platform merchants can be generated in the system based on their values in the feature store.

The central server computer can evaluate the performance using a weighted decile cohort percentage error (CPE) and a decile rank score. The central server computer can generate the weighted decile cohort percentage error and the decile rank score.

The weighted decile CPE can be used to track the performance of the machine learning model prediction (e.g., the performance of the predictions created during step 610). The central server computer can evaluate 1) the sales of service providers who have had at least a predetermined number of days since onboarding (e.g., allowing the use of the server computer to perform service processing for the service provider) against 2) the model's predictions of the service providers' sales for that period. The percentage error is calculated by comparing the predicted sales and the actual sales for service providers with the same decile rank. Weights are applied based on the service providers' average monthly sales to emphasize service providers with higher predicted values as accurately as possible.

The decile rank score is used as a measure of how decile rankings are affected by the predictions. The decile rank score uses a balance score table to calculate the difference between predicted ranks and actual ranks. The greater the difference, the higher the balance points are. Table 2, below, shows the balance points associated with each actual vs predicted decile rank combination. The weighted average score is calculated based on the merchant count in each cell.

These metrics measure the model performance in two ways. The weighted CPE shows how accurate the predictions are, indicating how well the central server computer understands the potential of the service providers. The weighted CPE can be desirable for planning and goal setting. The decile rank score measures how accurately the central server computer is ranking the off-platform merchants.

The central server computer can utilize Table 2 to improve the machine learning model. The central server computer can determine an actual decile rank and a predicted decile rank of each service provider (e.g., 100 service providers). The central server computer can determine the difference between the actual decile rank and the predicted decile rank. The difference, which is the decile rank score, can indicate how off (e.g., wrong) the prediction was.

As an example, if all of the service providers end up with a decile rank score of 0, then the central server computer can determine that the machine learning model is accurately predicting values for the service providers. This is because the actual values of the service providers, after being allowed to use the central server computer for service processing, match the predicted values.

As another example, if a first half of the service providers end up with a decile rank score of 5 and a second half of the service providers end up with a decile rank score of 0, then the central server computer can determine that the first half of the service providers are not being accurately predicted, while the second half of the service providers are being accurately predicted. The central server computer can evaluate the data relating to the service providers and the features to determine why the first half of the service providers have inaccurate predictions.

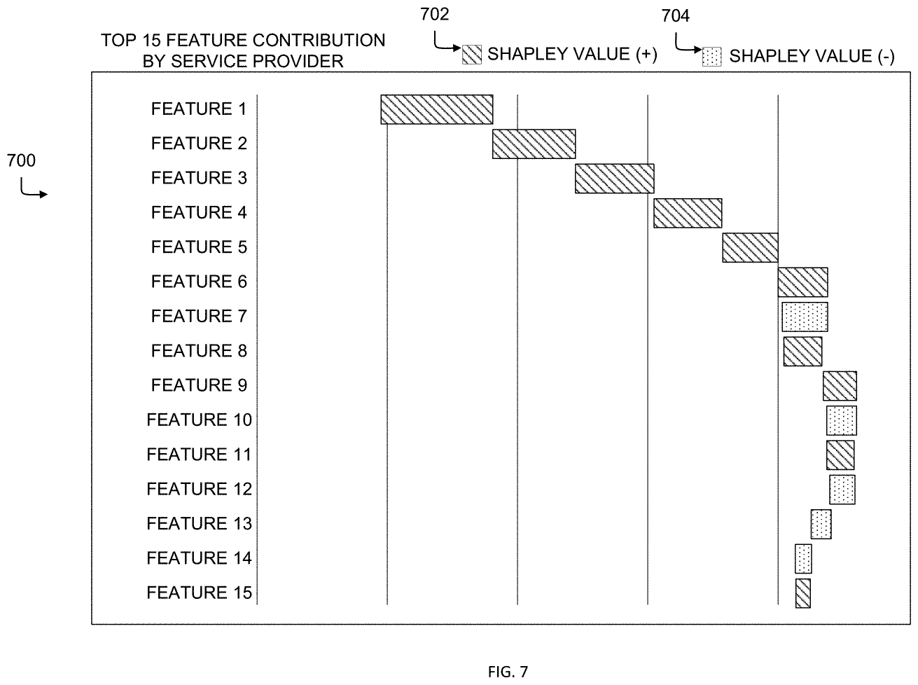

The central server computer or a data analysis, can evaluate the most influential features for each service provider (e.g., as illustrated in FIG. 7). The central server computer can search for patterns in features and the influence the features have on the predicted values. For example, the central server computer can evaluate the first half of the service providers, and can determine that the first half of the service providers all have a most influential feature of “location.” The central server computer can evaluate the second half of the service providers, and can determine that the second half of the service providers all have a most influential feature of “cuisine.”

Since the first half of service providers have inaccurate predictions and have most a most influential feature of “location,” the central server computer can determine that machine learning model needs to be trained with additional data relating to locations. For example, the central server computer can adjust the machine learning model to look at other data specific to the location, such as crime rate, traffic patterns, weather in the area, etc. Such additional data may influence the outcome of the predictions of the machine model. The central server computer can determine new predicted values for the service providers based on the updated trained machine learning model. If the service providers have decile ranks closer to 0, then the machine learning model has been improved and provides more accurate predictions.

TABLE 2
Balance scores for actual decile rank
vs predicted decile rank difference.

| | Actual | | | | | | | | | |
|---|---|---|---|---|---|---|---|---|---|---|
| Predicted | 1 | 2 | 3 | 4 | 5 | 6 | 7 | 8 | 9 | 10 |
| 1 | 0 | 1 | 2 | 3 | 4 | 5 | 6 | 7 | 8 | 9 |
| 2 | 1 | 0 | 1 | 2 | 3 | 4 | 5 | 6 | 7 | 8 |
| 3 | 2 | 1 | 0 | 1 | 2 | 3 | 4 | 5 | 6 | 7 |
| 4 | 3 | 2 | 1 | 0 | 1 | 2 | 3 | 4 | 5 | 6 |
| 5 | 4 | 3 | 2 | 1 | 0 | 1 | 2 | 3 | 4 | 5 |
| 6 | 5 | 4 | 3 | 2 | 1 | 0 | 1 | 2 | 3 | 4 |
| 7 | 6 | 5 | 4 | 3 | 2 | 1 | 0 | 1 | 2 | 3 |
| 8 | 7 | 6 | 5 | 4 | 3 | 2 | 1 | 0 | 1 | 2 |
| 9 | 8 | 7 | 6 | 5 | 4 | 3 | 2 | 1 | 0 | 1 |
| 10 | 9 | 8 | 7 | 6 | 5 | 4 | 3 | 2 | 1 | 0 |

At step 614, after evaluating performance metrics, the central server computer can provide data to a dashboard for users of the central server computer to interact with and view. In some embodiments, the central server computer can evaluate model performance data and automatically adjust weights, features, data, etc. to improve the machine learning model.

The dashboard can output a variety of metrics of the machine learning model. Example aspects of the dashboard can include a model/feature debugging dashboard 616, a model performance dashboard 618, and a model interpretation dashboard 620. For example, the model/feature debugging dashboard may display Shapley values of the plurality of features can be displayed to determine if one or more of the plurality of features are dominant.

The model/feature debugging dashboard 616 can allow users of the central server computer to evaluate the machine learning model and the features utilized by the machine learning model. The central server computer, or users of the central server computer, can evaluate the machine learning model and the features for errors.

The model performance dashboard 618 can allow users of the central server computer to evaluate the performance of the machine learning model. For example, the model performance dashboard 618 can display performance metrics, determined during step 612, to the users.

The model interpretation dashboard 620 can allow users of the central server computer to view and interpret the machine learning model and predicted outputs of the machine learning model. For example, the model interpretation dashboard 620 can display a feature contribution score graph, as illustrated in FIG. 7.

FIG. 7 shows a graph 700 illustrating a feature contribution by score according to embodiments. The graph 700 illustrated in FIG. 7 is a Shapley graph. Metrics are logged during the machine learning training process, including R-squared values and ranking metrics. Each feature from the data (e.g., features 406) of a candidate service provider can affect the outcome of the predicted value and the predicted rank. The amount that the feature effects the predicted value can be measured.

The graph 700 illustrates an amount of influence that the 15 most influential features have on the predicted value. The features are ordered by the size of their influence on the predicted value. The amount of influence that the feature has on the predicted value can be a Shapley value. The Shapley values can be computed to interpret feature contributions at the service provider level. The Shapley values can either be positive 702 or negative 704. All of the features together steer the ultimate direction of the final predicted value.

The graph 700 can be helpful to monitor the machine learning models over time. If there are big changes in important features, the central server computer can evaluate the training data to make sure there are no errors in the model training process. Shapley values are also helpful to answer questions about the reasoning behind a specific predicted values.

Embodiments of the disclosure have a number of technical advantages. For example, the central server computer can fairly compare service providers with one another at different time periods (e.g., time on the platform) to determine accurate predicted values. Further, embodiments of the invention can utilize different sources of data including external data sources and internal data sources to identify user intent features, off-platform features, and on-platform features. This combination of features can then be used to produce a machine learning model that accurately predicts whether or not a service provider would ultimately be successful if the service provider uses the above-described central server computer to perform its services. By doing so, service providers that would not be successful when using the above-described central server computer are identified, and the time and resources needed to allow them to use the central server computer are not wasted.

Embodiments provide for a number of additional advantages. For example, the central server computer can reduce the length of time needed to identify, evaluate, and select candidate service provider computers. This is because, it is time consuming to communicate with hundreds of thousands of service providers to evaluate whether or not to cooperate with any of the service providers.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

All patents, patent applications, publications, and descriptions mentioned above are herein incorporated by reference in their entirety for all purposes. None is admitted to be prior art.

What is claimed is:

1. A method comprising:
receiving, by a server computer, a dataset comprising data associated with a plurality of service providers;
extracting, by the server computer, a plurality of features from the dataset, wherein the features include user intent features, off-platform features, and on-platform features;
training, by the server computer, a machine learning model using training data based on the plurality of features of at least some of the service providers; and
for one or more candidate service providers of the plurality of service providers, determining, by the server computer, a predicted rank and a predicted value for each of the one or more candidate service providers using the trained machine learning model.

2. The method of claim 1, wherein the dataset comprises external data and internal data.

3. The method of claim 1 further comprising:
evaluating, by the server computer, the predicted rank and the predicted value for each of the one or more candidate service providers; and
responsive to evaluating, selecting, by the server computer, at least one of the one or more candidate service providers to use the server computer to perform service processing.

4. The method of claim 3 further comprising:
initiating, by the server computer, use of the server computer to perform service processing for the selected candidate service provider;
receiving, by the server computer from an end user device, a fulfillment request message comprising one or more items and indicating to use the selected candidate service provider, the fulfillment request message associated with a fulfillment request;
providing, by the server computer, the fulfillment request message, or a derivative thereof, to the selected candidate service provider, wherein the selected candidate service provider initiates preparation of the one or more items;
determining, by the server computer, one or more transporter user devices;
providing, by the server computer, the fulfillment request message to the one or more transporter user devices, wherein the one or more transporter user devices determine whether or not to request to accept the fulfillment request message;
receiving, by the server computer, an acceptance message from a transporter user device of the one or more transporter user devices;
generating, by the server computer, an update message indicating the status of the fulfillment request; and
providing, by the server computer, the update message to the end user device.

5. The method of claim 3 further comprising:
after a predetermined amount of time, obtaining, by the server computer, data from the one or more candidate service providers;
including, by the server computer, the data from the one or more candidate service providers into the dataset;
extracting, by the server computer, an additional plurality of features from the dataset;
training, by the server computer, the machine learning model using the training data that is further based on the additional plurality of features; and
for one or more additional candidate service providers of the plurality of service providers, determining, by the server computer, an additional predicted rank and an additional predicted value for each of the one or more additional candidate service providers using the trained machine learning model.

6. The method of claim 1, wherein the machine learning model comprises a gradient boosted trees supervised learning model with a squared error loss function.

7. The method of claim 1 further comprising:
outputting, by the server computer, metrics associated with the machine learning model, wherein the metrics comprise at least a Shapley value of each of the plurality of features of the dataset.

8. The method of claim 1, wherein the user intent features include user search queries and user service provider requests, wherein the off-platform features include service provider performance history, service provider ratings, service provider reviews, and service provider hours, and wherein the on-platform features include previously selected service provider performance history.

9. The method of claim 1 further comprising:
generating, by the server computer, a weighted decile cohort percentage error and a decile rank score using the predicated value.

10. The method of claim 9 further comprising:
evaluating, by the server computer, a newly selected service provider using the weighted decile cohort percentage error and the decile rank score to determine performance of the newly selected service provider.

11. A server computer comprising:
a processor; and
a computer-readable medium coupled to the processor, the computer-readable medium comprising code executable by the processor for implementing a method comprising:
receiving a dataset comprising data associated with a plurality of service providers;
extracting, by the server computer, a plurality of features from the dataset, wherein the features include user intent features, off-platform features, and on-platform features;
training a machine learning model using training data based on the plurality of features of at least some of the service providers; and
for one or more candidate service providers of the plurality of service providers, determining a predicted rank and a predicted value for each of the one or more candidate service providers using the trained machine learning model.

12. The server computer of claim 11, wherein the machine learning model comprises a gradient boosted trees supervised learning model.

13. The server computer of claim 11, wherein the method further comprises:
evaluating the predicted rank and the predicted value for each of the one or more candidate service providers to determine which candidate service providers would successfully perform when using the server computer for service processing;
selecting, by the server computer, at least one of the one or more candidate service providers to use the server computer to perform service processing;
initiating use of the server computer to perform service processing for the selected candidate service provider;
after a predetermined amount of time, obtaining data from the selected candidate service provider;
including the data from the one or more candidate service providers into the dataset;
extracting an additional plurality of features from the dataset;
training the machine learning model using the training data that is further based on the additional plurality of features; and
for one or more additional candidate service providers of the plurality of service providers, determining an additional predicted rank and an additional predicted value for each of the one or more additional candidate service providers using the trained machine learning model.

14. The server computer of claim 13, wherein the predetermined amount of time has a length between 4-6 months.

15. The server computer of claim 11, wherein extracting the plurality of features from the dataset comprises:
extracting the plurality of features using principle component analysis, independent component analysis, linear discriminant analysis, local linear embeddings, and/or autoencoders.

16. The server computer of claim 11, wherein training the machine learning model using training data based on the plurality of features of at least some of the service providers comprises:
training a first machine learning model using first training data based on the plurality of features of a first group of the service providers; and
training a second machine learning model using second training data based on the plurality of features of a second group of the service providers.

17. The server computer of claim 16, wherein the first group includes service providers associated with a first characteristic and wherein the second group includes service providers associated with a second characteristic.

18. The server computer of claim 17, wherein the first characteristic is a chain service provider, wherein the second characteristic is a local service provider.

19. A system comprising:
a server computer comprising:
a first processor; and
a first computer-readable medium coupled to the first processor, the first computer-readable medium comprising code executable by the first processor for implementing a method comprising:
receiving a dataset comprising data associated with a plurality of service providers;
extracting, by the server computer, a plurality of features from the dataset, wherein the features include user intent features, off-platform features, and on-platform features;
training a machine learning model using training data based on the plurality of features of at least some of the service providers; and
for one or more candidate service providers of the plurality of service providers, determining a predicted rank and a predicted value for each of the one or more candidate service providers using the trained machine learning model; and
a logistics platform comprising:
a second processor; and
a second computer-readable medium coupled to the second processor, the second computer-readable medium comprising code executable by the second processor.

20. The system of claim 19, wherein the method further comprises:
evaluating the predicted rank and the predicted value for each of the one or more candidate service providers for to determine which candidate service providers would successfully perform when using the server computer for service processing;
selecting, by the server computer, at least one of the one or more candidate service providers to use the server computer to perform service processing;
initiating use of the server computer to perform service processing for the selected candidate service provider;
after a predetermined amount of time, obtaining data from the selected candidate service provider;
including the data from the one or more candidate service providers into the dataset;
extracting an additional plurality of features from the dataset;
training the machine learning model using the training data that is further based on the additional plurality of features; and
for one or more additional candidate service providers of the plurality of service providers, determining an additional predicted rank and an additional predicted value for each of the one or more additional candidate service providers using the trained machine learning model.
